(19) United States
(12) Patent Application Publication
(10) Pub. No.: US 2007/0193839 A1
(43) Pub. Date: Aug. 23, 2007

(54) Variable attenuation power damper

(75) Inventors: Kiyoshi Nakajima, Saitama (JP); Tatsuhiro Tomari, Saitama (JP); Toru Sukigara, Saitama (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/709,807

(22) Filed: Feb. 23, 2007

(30) Foreign Application Priority Data
Feb. 23, 2006 (JP) P.2006-046728
Feb. 23, 2006 (JP) P.2006-046729
Feb. 16, 2007 (JP) P.2007-035866

(51) Int. Cl. F16F 9/53

(52) U.S. Cl. 188/267.2

(57) ABSTRACT

An attenuation power control mechanism which changes opening of orifices 46, 47 of a piston 25 fitted into a cylinder 22 includes first and second valve plates 37, 38, and first and second coils 44, 45 which generate magnetic fields, whereby the first and second valve plates 37, 38 are deformed by the magnetic fields generated by the first and second coils 44, 45 to change the opening of the orifices 46, 47, so that the attenuation power of the damper can be controlled arbitrarily. At this time, the first valve plate 37 is deformed by the corresponding first coil 44, and the second valve plate 38 is deformed by the corresponding second coil 45.

### BACKGROUND OF THE INVENTION

The present invention relates to a variable attenuation power damper which includes a magnetic alloy made valve plate and a coil which generates a magnetic filed, and changes the shape of the valve plate by the magnetic filed generated by the coil thereby to make arbitrary control of attenuation power possible.

As well-known art, there is a variable attenuation power damper disclosed in the following Patent Document 1, in which a cylinder filled with viscous fluid is separated into first and second fluid chambers by a piston slidably fitted into the inside of the cylinder, and a spool valve which is opened and closed by a solenoid is arranged in a fluid passage which penetrates the piston and communicates the first and second fluid chambers with each other. According to this variable attenuation power damper, attenuation power of the damper can be controlled arbitrarily by energizing the solenoid and changing the opening of the spool valve.

[Patent Document] JP-A-2004-225834

Since it is necessary for the variable attenuation power damper described in the above Patent Document 1 to arrange in the piston the spool valve which is operated by the solenoid, the number of parts increases and the structure becomes complicated. In addition, since time lag exists after the solenoid is energized till the opening of the spool valve changes, there is a problem of low response.

Therefore, the present applicant has proposed in patent application Ser. No. 2005-231925 a variable attenuation power damper, which controls attenuation power by deforming a valve plate made of magnetic alloy which opens and closes an orifice provided in the piston by means of a coil provided in the piston.

This variable attenuation power damper, compared with the variable attenuation power damper described in the above Patent Document 1, can obtain high response. However, when the frequency of load inputted in the piston becomes high, the coil must repeat excitation and demagnetization at short time intervals. Therefore, rising of electric current in excitation time is delayed due to an influence of inductance of the coil, with the result that there is possibility that the response lowers.

Further, this variable attenuation power damper, compared with the variable attenuation power damper described in the above Patent Document 1, can obtain high response. However, since the attenuation power of the damper is adjusted by the opening of the orifice, it is difficult to sufficiently expand the adjustable width of the attenuation power by heightening the maximum attenuation power of the damper.

### SUMMARY OF THE INVENTION

The invention is made in view of the above circumstances, and it is an object of the invention to heighten response that the valve plates deform when the piston of the variable attenuation power damper reciprocates at a short cycle.

Further, the invention is made in view of the above circumstances, and it is an object of the invention to heighten the maximum attenuation power which the variable attenuation power damper can generate thereby to expand the adjustable width of the attenuation power.

In order to achieve the above object, according to a first aspect of the invention, there is provided a variable attenuation power damper including:

a cylinder filled with viscous fluid;

a piston which is fitted slidably into the cylinder and separates the cylinder into first and second fluid chambers;

a piston rod which is coupled to the piston and penetrates an end wall of the cylinder;

orifices which are provided in the piston and through which the first and second fluid chambers are communicated with each other; and

an attenuation power control mechanism which controls attenuation power by changing the opening of the orifices of the piston, wherein the attenuation power control mechanism includes:

first and second valve plates which are made of magnetic alloy and arranged at both ends in the axial direction of the piston; and

first and second coils which are arranged in the piston to correspond to the first and second valve plates respectively, and

the first and second valve plates are respectively deformed by magnetic fields generated by the first and second coils to change the opening of the orifices.

Further, according to a second aspect of the invention, there is provided the variable attenuation power damper of the first aspect, wherein

the piston includes fluid passages which communicate the first and second fluid chambers with each other in cooperation with the orifices, and

the fluid passages are arranged on the inside in the diametrical direction of the first and second coils provided in the piston.

Further, according to a third aspect of the invention, there is provided a variable attenuation power damper including:

a cylinder filled with viscous fluid;

a piston which is fitted slidably into the cylinder and separates the cylinder into first and second fluid chambers;

a piston rod which is coupled to the piston and penetrates an end wall of the cylinder;

orifices which are provided in the piston and through which the first and second fluid chambers are communicated with each other; and

an attenuation power control mechanism which controls attenuation power by changing the opening of the orifices of the piston, wherein

the viscous fluid is composed of magnetic viscous fluid or magnetic fluid; and

the attenuation power control mechanism includes valve plates which are made of magnetic alloy and arranged in the piston and coils, and

the valve plates are deformed by magnetic fields generated by the coils to change the opening of the orifices.

Further, according to a forth aspect of the invention, there is the variable attenuation power damper of the third aspect, wherein

the valve plate includes first and second valve plates arranged at both ends in the axial direction of the piston, and

the coil includes first and second coils respectively corresponding to the first and second valve plates.

Further, according to a fifth aspect of the invention, a variable attenuation power damper is proposed, which is characterized, in addition to the constitution of the second aspect, in that a piston body of the piston is formed of one member from one end in its axial direction to the other end.

Further, according to a sixth aspect of the invention, a variable attenuation power damper is proposed, which is characterized, in addition to the constitution of any one of the first to third aspects, in that the piston rod is inserted from one end in the axial direction of the piston and located on this side of the other end in the axial direction thereof.

Further, according to a seventh aspect of the invention, a variable attenuation power damper is proposed, which includes a cylinder filled with viscous fluid; a reservoir room which is arranged so as to surround the periphery of the cylinder, communicates at its lower portion with the cylinder thereby to be filled with the viscous fluid, and is filled at its upper portion with gas; a movable piston which is fitted into the cylinder slidably and divides the cylinder into first and second fluid chambers; a piston rod which is coupled to the movable piston and penetrates an end wall of the cylinder; a first orifice which is provided in the movable piston and through which the first and second fluid chambers are communicated with each other; a first attenuation power control mechanism which changes the opening of the first orifice of the movable piston thereby to control the attenuation power; a fixed piston which is fixed at the bottom of the cylinder so as to define the second fluid chamber and the reservoir room; a second orifice which is provided in the fixed piston and through which the second fluid chamber and the reservoir room are communicated with each other; and a second attenuation power control mechanism which changes the opening of the second orifice of the fixed piston thereby to control the attenuation power. Herein, the first attenuation power control mechanism includes a first valve plate made of magnetic alloy which is arranged at the lower end in the axial direction of the movable piston, and a first coil arranged in the movable piston so as to correspond to the first valve plate, and deforms the first valve plate by the magnetic field generated by the first coil thereby to change the opening of the first orifice; and the second attenuation power control mechanism includes a second valve plate made of magnetic alloy which is arranged at the lower end in the axial direction of the fixed piston, and a second coil arranged in the fixed piston so as to correspond to the second valve plate, and deforms the second valve plate by the magnetic field generated by the second coil thereby to change the opening of the second orifice.

First and second orifices 46 and 46 in an embodiment of the invention correspond to the orifices of the invention, and first and second fluid passages 39 and 40 therein correspond to the fluid passages of the invention.

According to the constitution in the first aspect, the attenuation power control mechanism which changes the opening of the orifices provided in the piston which is fitted slidably into the cylinder filled with the viscous fluid includes the first and second valve plates which are made of magnetic alloy, and the first and second coils which generate the magnetic fields. Therefore, by deforming the first and second valve plates by the magnetic fields generated by the first and second coils to change the opening of the orifices, the attenuation power of the damper can be controlled arbitrarily. In this case, the first valve plate is deformed by the corresponding first coil, and the second valve plate is deformed by the corresponding second coil. Hereby, compared with the case where these first and second valve plates are deformed by a common coil, the time interval for which the first and second coils are excited and demagnetized can be extended twice. Hereby, the influence of the inductance of the first and second coils can be suppressed to a minimum thereby to accelerate rising of the electric current, and response in high-frequency input to the damper can be heightened.

Further, according to the constitution in the second aspect, the fluid passages which communicate the first and second fluid chambers with each other in cooperation with the orifices are arranged on the inside in the diametrical direction of the first and second coils provided in the piston. Therefore, even in case that the first and second valve plates are about to be opened by pressure of the fluid which flows in the fluid passages, the magnetic power generated by the coil enables the first and second valve plates to close surely against the pressure of the fluid.

According to the constitution in the third aspect, the orifices are provided in the piston which is fitted slidably into the cylinder filled with the magnetic viscous fluid or the magnetic fluid, and the attenuation power of the damper can be controlled arbitrarily by deforming the valve plates provided in the piston by the magnetic fields generated by the coils and changing the opening of the orifices. In this case, by changing the viscosity of the magnetic viscous fluid or the magnetic fluid in the orifices by the magnetic fields which the coils generate, the attenuation power of the damper can be controlled arbitrarily. Thus, by combining the attenuation power generated by the orifice and the valve plate and the attenuation power generated by the magnetic viscous fluid or the magnetic fluid, the large attenuation power is generated, so that the adjustable width of the attenuation power can be expanded.

Further, according to the constitution in the forth aspect, the first valve plate is deformed by the corresponding first coil, and the second valve plate is deformed by the corresponding second coil. Therefore, compared with the case where these first and second valve plates are deformed by a common coil, the time interval for which the first and second coils are excited and demagnetized can be extended twice. Hereby, the influence of the inductance of the first and second coils can be suppressed to a minimum thereby to accelerate rising of the electric current, and response in high-frequency input time to the damper can be heightened.

Further, according to the constitution in the fifth aspect, the piston body of the piston is formed of one member from one end in its axial direction to the other end. Therefore, phase-matching of the fluid passages required in case that the piston body is formed of plural members is unnecessary, so that the number of parts and the number of assembly steps can be reduced.

Further, according to the constitution in the sixth aspect, the piston rod is inserted from one end in the axial direction of the piston and located on this side of the other end in. the axial direction thereof. Therefore, it is possible to suppress reduction of the volume of the piston functioning as a yoke by the piston rod to a minimum, and it is possible to heighten the absorption power of the first and second valve plates without increasing the electric current to be supplied to the first and second coils.

Further, according to the constitution in the seventh aspect, the first attenuation power control mechanism which changes the opening of the first orifice provided in the movable piston that is slidably fitted into the cylinder filled with the viscous fluid includes the first valve plate made of magnetic alloy and the first coil which generates the magnetic field, and the second attenuation power control mechanism which changes the opening of the second orifice provided in the fixed piston that is fixed between the cylinder and the reservoir room includes the second valve plate made of magnetic alloy and the second coil which generates the magnetic field, whereby the first and second valve plates are deformed by the magnetic fields generated by the first and second coils thereby to change the opening of the first and second orifices, and the attenuation power of the damper can be arbitrarily controlled. In this case, the first valve plate is deformed by the corresponding first coil, and the second valve plate is deformed by the corresponding second coil, whereby a time interval in which the first and second coils are excited and demagnetized can be prolonged twice, compared with the case where these first and second valve plates are deformed by a common coil. Hereby, the influence of the inductance of the first and second coils can be suppressed to a minimum thereby to accelerate rising of the electric current, and response in high-frequency input to the damper can be heightened.

### BRIEF DESCRIPTION OF THE DRAWINGS

FIG. 1 is a front view of a suspension system in a vehicle according to a first embodiment of the invention.

FIG. 2 is an enlarged sectional view of a variable attenuation power damper.

FIG. 3 is an enlarged sectional view taken along a line 3-3 in FIG. 2.

FIG. 4 is a sectional view taken along a line 4-4 in FIG. 3 (in non-excitation and low-speed time).

FIG. 5 is a sectional view taken along a line 5-5 in FIG. 3 (in non-excitation and low-speed time).

FIG. 6 is an action explanatory view corresponding to FIG. 4 (in excitation and high-speed time).

FIG. 7 is an action explanatory view corresponding to FIG. 5 (in excitation and high-speed time).

FIG. 8 is a graph showing a relation between piston speed and attenuation power.

FIG. 9 is a graph for explaining an effect of magnetic viscous fluid.

FIG. 10 is a diagrams corresponding to FIG. 4, according to a second embodiment of the invention.

FIG. 11 is a diagrams corresponding to FIG. 5, according to a third embodiment of the invention.

### DETAILED DESCRIPTION OF THE PREFERRED EMBODIMENTS

### First Embodiment

An embodiment of the invention will be described below with reference to attached drawings.

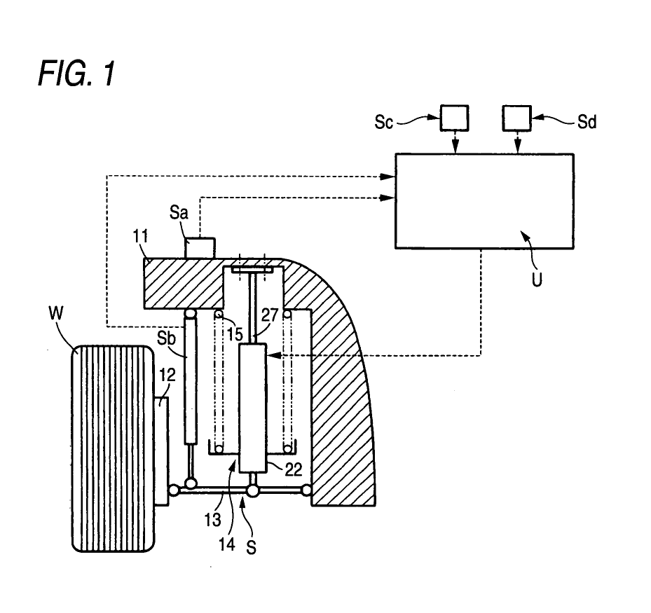

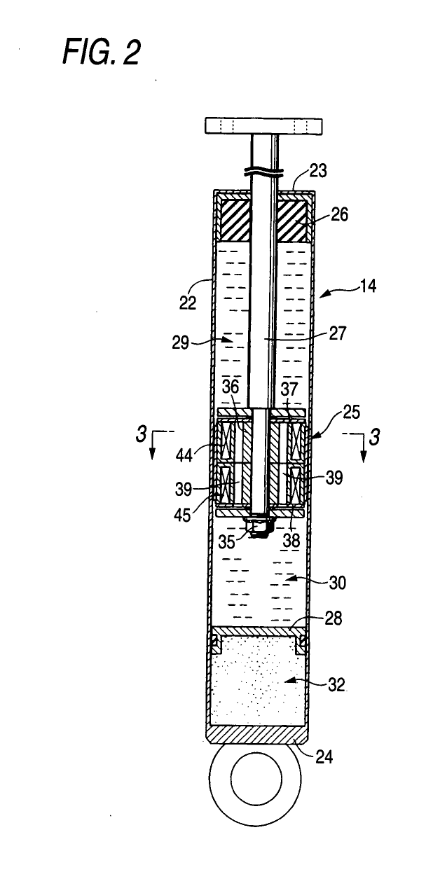

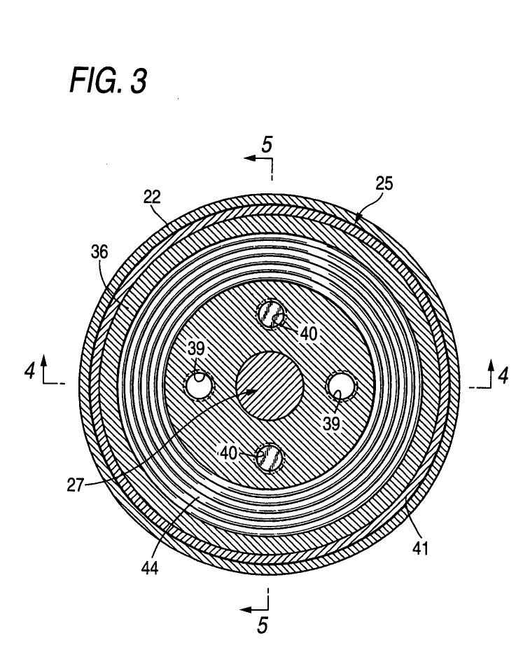

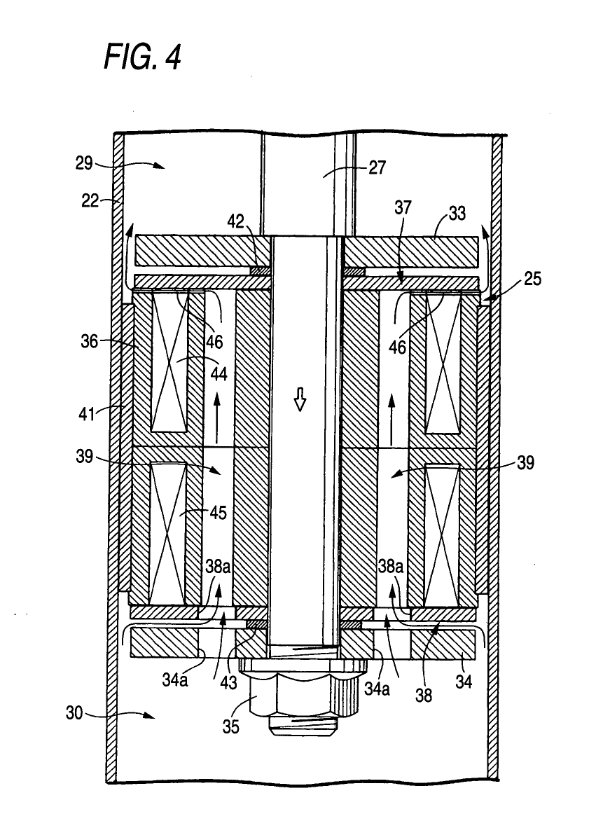

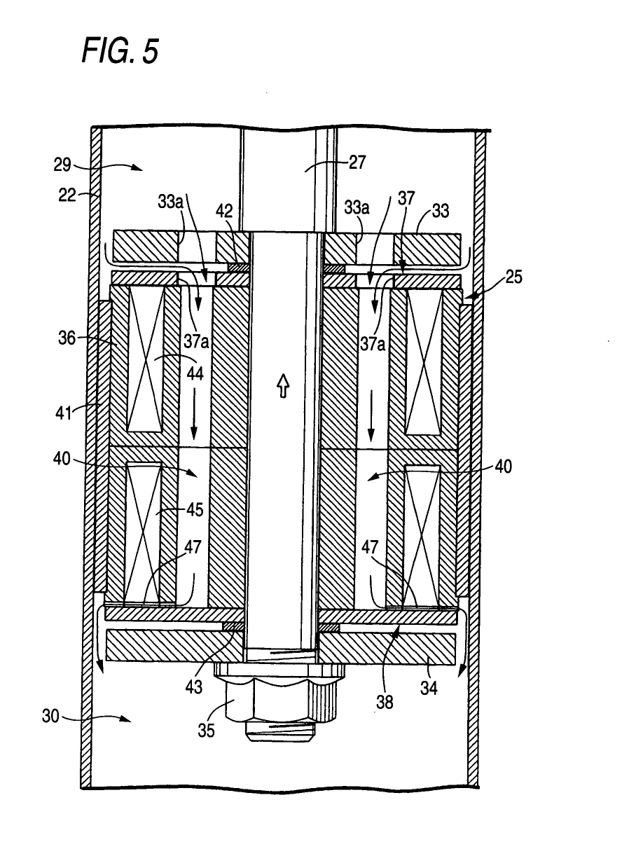

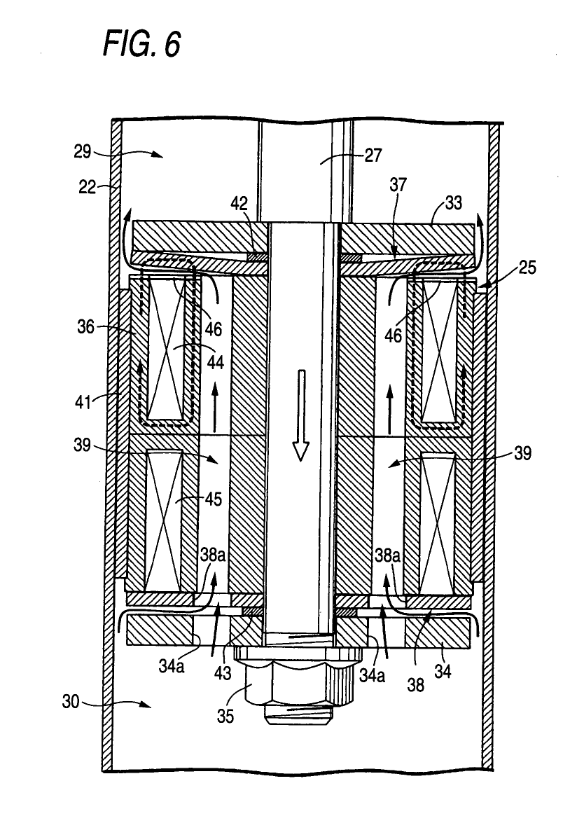

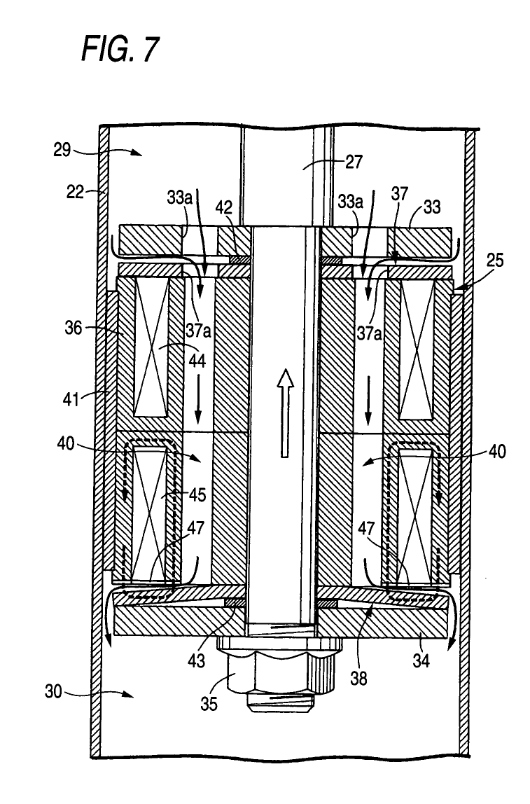

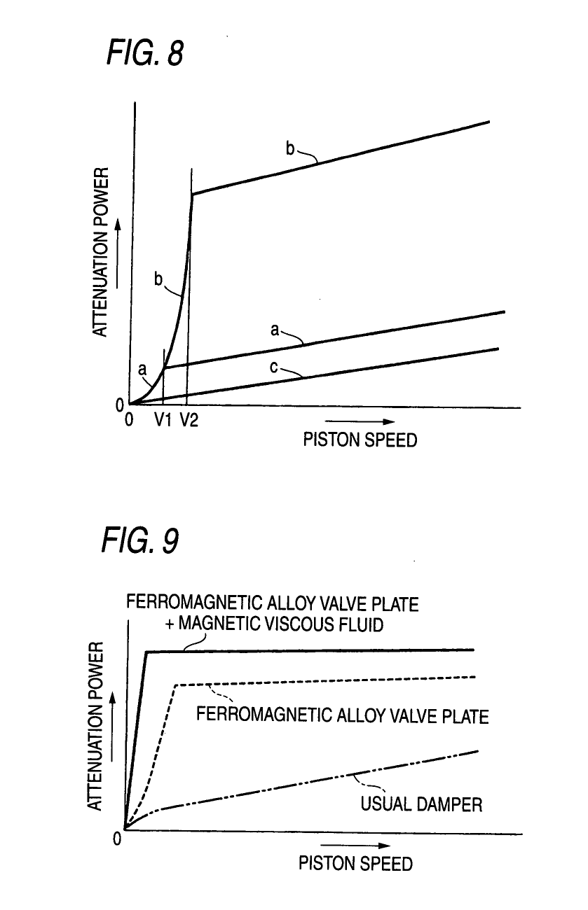

FIGS. 1 to 9 show a first embodiment of the invention, in which FIG. 1 is a front view of a suspension system in a vehicle, FIG. 2 is an enlarged sectional view of a variable attenuation power damper, FIG. 3 is an enlarged sectional view taken along a line 3-3 in FIG. 2, FIG. 4 is a sectional view taken along a line 4-4 in FIG. 3 (in non-excitation and low-speed time), FIG. 5 is a sectional view taken along a line 5-5 in FIG. 3 (in non-excitation and low-speed time), FIG. 6 is an action explanatory view corresponding to FIG. 4 (in excitation and high-speed time), FIG. 7 is an action explanatory view corresponding to FIG. 5 (in excitation and high-speed time), FIG. 8 is a graph showing a relation between piston speed and attenuation power, and FIG. 9 is a graph for explaining effects of magnetic viscous fluid.

As shown in FIG. 1, a suspension system S which suspends wheels W of four wheel automobile includes a suspension arm 13 which supports a knuckle 12 movably in the up-and-down direction in relation to a body 1, a variable attenuation power damper 14 which connects the suspension arm 13 and the body 11, and a coil spring 15 which connects the suspension arm 13 and the body 11. To an electronic control unit U which controls attenuation power of the damper 14, a signal from a sprung acceleration sensor Sa which detects sprung acceleration, a signal from a damper displacement sensor Sb which detects displacement (stroke) of the damper 14, a signal from a steering angle sensor Sc which detects a steering angle of the vehicle, and a lateral acceleration sensor Sd which detects lateral acceleration of the vehicle are inputted.

As shown in FIG. 2, the damper 14 includes a cylinder 22 of which a lower end is connected to the suspension arm 13, a upper end plate 23 and a lower end plate 24 which block the upper end and the lower end of the cylinder 22 respectively, a piston 25 which is slidably fitted into the cylinder 22, a piston rod 27 which extends from the piston 25 upward, and penetrates a seal member 26 provided for the upper end plate 23 liquid-tightly, and of which the upper end is connected to the body 11, and a free piston 28 which is slidably fitted into the cylinder 22 at the lower portion of the cylinder 22.

The inside of the cylinder 22 is partitioned by the piston 25 into a first fluid chamber 29 located on the upper side and a second fluid chamber 30 located on the lower side. These first and second fluid chambers 29 and 30 are filled with magnetic viscous fluids (MRF: Magneto-Rheological Fluids). Further, at the lower portion of the free piston 28, a gas chamber 32 in which high-pressure gas is sealed is defined.

As shown in FIGS. 3 to 5, the piston 25 includes a pair of upper and lower piston bodies 36, 36 which are fixed to the piston rod 27 by a nut 35 through stopper plates 33, 34 that are a pair of upper and lower non-magnetic matters, and shims 42, 43 that are magnetic matters. Between the upper surface of the upper piston body 36 and the shim 42, a center portion of a first valve plate 37 formed of disc-shaped ferromagnetic alloy is fixed. Further, between the lower surface of the lower piston body 36 and the shim 43, a center portion of a second valve plate 38 formed of disc-shaped ferromagnetic alloy is fixed. Four fluid passages 39, 39 and 40, 40 penetrate the both piston bodies 36, 36 in the axial direction at 90 degrees spacing. The two first fluid passages 39, 39 of them are arranged at both ends in the diametrical direction of the piston body 36, and the other second fluid passages 40, 40 are arranged at both ends in the diametrical direction thereof, which are shifted 90° away from the first fluid passages 39, 39.

In the second valve plate 38, permeable pores 38a, 38a (refer to FIG. 4) which face lower ends of the first fluid passages 39, 39 are formed. Further, in the first valve plate 37, permeable pores 37a, 37a (refer to FIG. 5) which face upper ends of the second fluid passages 40, 40 are formed. Further, onto the peripheral surface of the both piston bodies 36, 36, a piston ring 41 which comes into slide-contact with the inner surface of the cylinder 22 is attached. In the stopper plate 33, permeable pores 33a, 33a are formed so as to face the permeable pores 37a, 37a of the first valve plate 37; and in the stopper plate 34, permeable pores 34a, 34a are formed so as to face the permeable pores 38a, 38a of the second valve plate 38.

Into the upper half portion of the upper piston body 36 which is an outer side in the diametrical direction than the portion where the first and second fluid passages 39, 39 and 40, 40 are located, an annular first coil 44 is buried so as to surround the piston rod 27. This first coil 44 is connected to the electronic control unit U and its energization is controlled. Further, into the lower half portion of the lower piston body 36 which is the outer side in the diametrical direction than the portion where the first and second fluid passages 39,39 and 40,40 are located, an annular second coil 45 is buried so as to surround the piston rod 27. This second coil 45 is connected to the electronic control unit U and its energization is controlled.

When the first coil 44 is excited, the first valve plate 37 is absorbed on the upper surface of the upper piston body 36. At this time, groove-shaped first orifices 46, 46 (refer to FIG. 4) are formed on the upper surface of the upper piston body 36 so that the upper ends of the first fluid passages 39, 39 communicate with the first liquid chamber 29. Further, when the second coil 45 is excited, the second valve plate 38 is absorbed on the lower surface of the lower piston body 36. At this time, groove-shaped second orifices 47, 47 (refer to FIG. 5) are formed on the lower surface of the lower piston body 36 so that the lower ends of the second fluid passages 40, 40 communicate with the second liquid chamber 30.

Next, the action of the first embodiment of the invention having the above constitution will be described.

As shown in FIG. 4, when the first and second coils 44, 45 are not excited, the damper 14 contracts and the piston 25 moves down in relation to the cylinder 22. Then, the volume of the first fluid chamber 29 increases and the volume of the second fluid chamber 30 decreases. Therefore, the magnetic viscous fluid in the second fluid chamber 30 flows through the permeable pores 38a, 38a of the second valve plate 38 into the first fluid passages 39, 39. At this time, the second valve plate 38 receives the fluid pressure in the valve closing direction and is pressed against the lower surface of the lower piston body 36. The magnetic viscous fluid that has passed through the first fluid passages 39, 39 energizes the lower surface of the first valve plate 37 in the valve opening direction (upward). However, the first valve plate 37 does not open due to its self-rigidity till the down-moving speed of the piston 25 comes to V1 in FIG. 8. Therefore, the magnetic viscous fluid flows in the first fluid chamber 29 through the first orifices 46, 46 located between the lower surface of the first valve plate 37 and the upper piston body 36, with the result that resistance is produced by the first orifices 46, 46 and the attenuation power of the damper 14 increases quickly.

When the down-moving speed of the piston 25 comes to V1 in FIG. 8, the first valve plate 37 yields to the fluid pressure and curves upward as shown in FIG. 6, and the first orifices 46, 46 do not function. Therefore, according to the increase in the down-moving speed of the piston 25, the attenuation power of the damper 14 increases linearly (refer to a line a).

At this time, when the first coil 44 is energized by an instruction from the electronic control unit U, the first valve plate 37 is about to deform downward due to the magnetic field generated by the first coil 44 and the set load in the valve closing direction is produced. Therefore, till the down-moving speed of the piston 25 increases more and comes to V2 in FIG. 8, the first valve plate 37 does not open, and rising of the attenuation power of the damper 14 becomes strong due to the function of the first orifice 42 (refer to a line b). Accordingly, by changing the electric current to be supplied to the first coil 44, the attenuation power of the damper 14 can be controlled arbitrarily.

When shock compression-load is applied to the damper 14 and the volume of the second fluid chamber 30 decreases, the free piston 28 descends while the gas chamber 32 is reduced, whereby the shock is absorbed. Further, when shock tensile-load is applied to the damper 14 and the volume of the second fluid chamber 30 increases, the free piston 28 ascends while the gas chamber 32 is expanded, whereby the shock is absorbed. Further, when the piston 25 descends and the volume of the piston rod 37 housed in the inner cylinder 22 increases, the free piston 28 descends so as to absorb its increase of the volume.

The magnetic viscous fluid filled in the first and second fluid chambers 29, 30, is obtained by dispersing magnetic microparticles such as iron powders in the viscous fluid such as oil, and has the following property: when the magnetic filed is applied to the magnetic viscous fluid, the magnetic microparticles align along a magnetic line of force, whereby the magnetic viscous fluid becomes difficult to flow and apparent viscosity increases. Therefore, when the first and second coils 44, 45 are excited and the magnetic fields are generated, the apparent viscosity of the magnetic viscous fluid in the first and second orifices 46, 46 and 47, 47 increases, so that the attenuation power of the damper 14 increases. This increase amount of the attenuation power can be controlled arbitrarily by the magnitude of the electric current to be supplied to the first and second coils 44, 45.

Accordingly, the attenuation power of the damper 14, as shown in a graph of FIG. 9, is represented by the sum of a component which changes according to the opening of the first and second orifices 46, 46 and 47, 47 and a component which changes according to the apparent viscosity of the magnetic viscous fluid, and the adjustable width of the attenuation power of the damper 14 can be expanded.

Although the case where the piston 25 moves down is described above, in case that the piston 25 moves up, the second coil 45 is exited in place of the first coil 44, whereby the similar action effect is achieved.

Thus, the electronic control unit U, on the basis of the. sprung acceleration detected by the sprung acceleration sensor Sa, the damper displacement detected by the damper displacement sensor Sb, the steering angle detected by the steering angle sensor Sc, and the lateral acceleration detected by the lateral acceleration sensor Sd, controls the attenuation power of the damper of each wheel W, that is, controls individually the attenuation power of totaling four dampers 14 . . . . Hereby, ride comfort control such as sky hook control in which the vehicle vibration when the vehicle gets over a rough road is suppressed thereby to heighten the ride comfort, and stable operation control in which rolling when the vehicles turns and pitching when the vehicle accelerates rapidly or decelerates rapidly are suppressed can be executed selectively according to the driving state of the vehicle.

Since the ferromagnetic alloy constituting the first and second valve plates 37, 38 is high in response to deformation for change of the magnetic fields, control response of the attenuation power of the damper 14 can be heightened. Further, according to the embodiment, by dividing the coil of the piston 25 into two of the first coil 44 and the second coil 45, the control response of the attenuation power of the damper 14 can be heightened.

Namely, the coil of the piston 25 is excited when the damper 14 contracts (the piston 25 moves down) and when the damper 14 expands (the piston 25 moves up); and if the number of the coils is one, the coil repeats a cycle of excitation and demagnetization two times per cycle of expansion and contraction of the damper 14. In case that the electric current to be supplied to the coil is thus intermitted, as the cycle of excitation and demagnetization becomes shorter, rising of electric current is delayed more upon reception of the influence of inductance of the coil. Therefore, the first and second valve plates 37, 38 cannot be absorbed quickly, with the result that there is a problem that the response lowers.

However, according to the embodiment, since the first and second coils 44, 45 are provided for the piston 25, the first coil 44 is excited only when the piston 25 moves down, and the second coil 45 is excited only when the piston 25 moves up. In result, the first and second coils 44, 45 performs only one cycle of excitation and demagnetization in one cycle of expansion and contraction of the damper 14, whereby the cycle of the electric current to be supplied to the first and second coils 44, 45 can be extended twice thereby to make the reception of influence of the inductance difficult, and the rising delay of the electric current can be suppressed to a minimum thereby to heighten the response.

Further, the first and second fluid passages 39,39 and 40,40 which communicate the first and second fluid chambers 29, 30 with each other in cooperation with the first and second orifices 46, 46 and 47, 47 are arranged on the inside in the diametrical direction of the first and second coils 44, 45 provided in the piston 25. Therefore, even in case that the first and second valve plates 37, 38 are about to be opened by pressure of the fluid which flows in the first and second fluid passages 39, 39 and 40, 40, the magnetic power generated by the first and second coils enables the first and second valve plates 37, 38 to close surely against the pressure of the fluid.

Although the embodiment of the invention is described above, various changes may be made in the design of the invention without departing from the spirit of the invention.

For example, although the damper 14 for the suspension system is illustrated in the embodiment, the variable attenuation power damper of the invention can be used for other arbitrary applications.

Further, although the magnetic viscous fluid is used as the working fluid in the embodiment, the usual viscous fluid may be used.

Further, although the first and second coils 44, 45 are provided in the embodiment, the number of the coils may be one.

### Second Embodiment

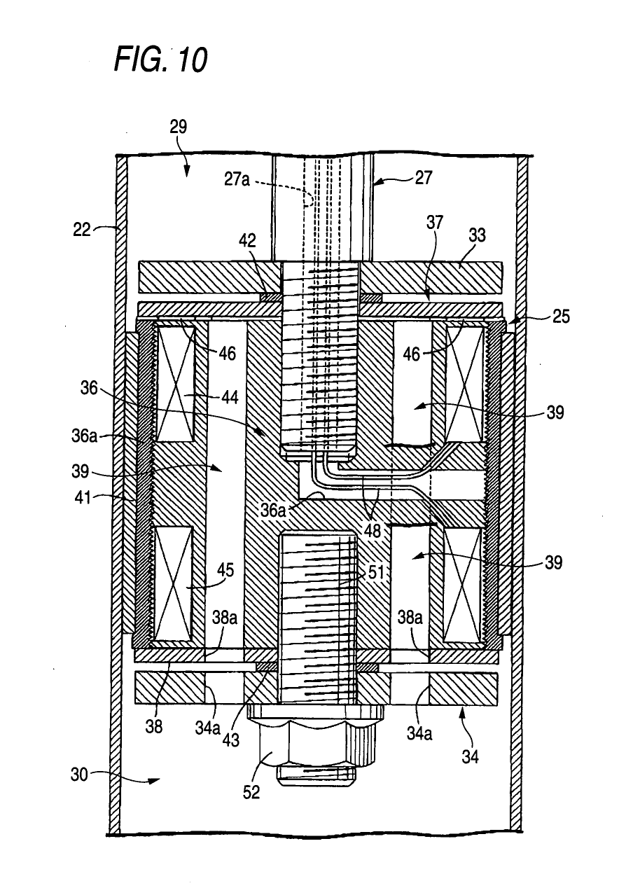

Next, referring to FIG. 10, a second embodiment of the invention will be described.

In the first embodiment, the two piston bodies 36, 36 are overlaid in the axial direction and fastened integrally by the piston rod 27 and the nut 35. In the second embodiment, the two-divided piston bodies 36, 36 are formed integrally. In result, it is not necessary for a piston rod 27 to penetrate the piston body 36 in the axial direction, and the piston rod 27 is integrally fitted into the piston body 36 from the upper surface of the piston body 36 to the less than half position of the axial length of the piston body 36. Onto the lower surface of the piston body 36, a second valve plate 38, a shim 43 and a stopper plate 34 are fixed by a bolt 51 which is separate from the piston rod 27 and a nut 52. Between the lower end of the piston rod 27 and the upper end of the bolt 51, the piston body 36 becomes solid, and the volume of the piston body 36 increases correspondingly.

Onto the peripheral surface of the piston body 36, that is, on the peripheral portions of first and second coils 44, 45 provided for the piston body 36, a cylindrical piston body peripheral portion 36a is screw-coupled. In the first embodiment, the wound first and second coils 44, 45 are attached from the axial end surfaces of the upper and lower piston bodies 36, 36. In the second embodiment, from the peripheral surface side of the piston body 36, the first and second coils 44, 45 are directly wound, and the outside in the diametrical direction of the piston body is covered with the piston body peripheral portion 36a, whereby assembly efficiency can be heightened, and the number of turns of the first and second coils 44, 45 is readily changed.

A harness 48 extending from the first and second coils 44, 45 is led from a harness insertion hole 36b formed inside the piston body 36 through a harness insertion hole 27a formed inside the piston rod 27 to the outside.

The function of a damper 14 in this second embodiment is the same as that of the damper 14 in the above first embodiment. Since the piston body 36 is formed integrally in the second embodiment, the following work effect can be further achieved.

Namely, since the axially two-divided piston bodies 36, 36 in the first embodiment are formed by one member, it is not necessary to let the piston rod 27 penetrate from the upper end of the piston body 36 to the lower end thereof, and the magnetic path sectional area of the piston body 36 functioning as a yoke is enlarged by the reduced length of the piston rod 27, so that the absorption power of the first and second valve plates 37 and 38 can be heightened with the same electric current as that in the first embodiment.

Further, in the first embodiment, since the piston body is divided into the two sections 36, 36 in the axial direction, when the two piston bodies 36, 36 are coupled to each other, phase-matching of first fluid passages 39 between the two piston bodies 36, 36 and phase-matching of second fluid passages 40 between the two piston bodies 36, 36 are necessary. However, in. the second embodiment, since the first fluid passages 39, 39 and the second fluid passages 40, 40 are formed in a single piston body 36, the phase-matching of them is unnecessary, so that the assembly efficiency improves.

### Third Embodiment

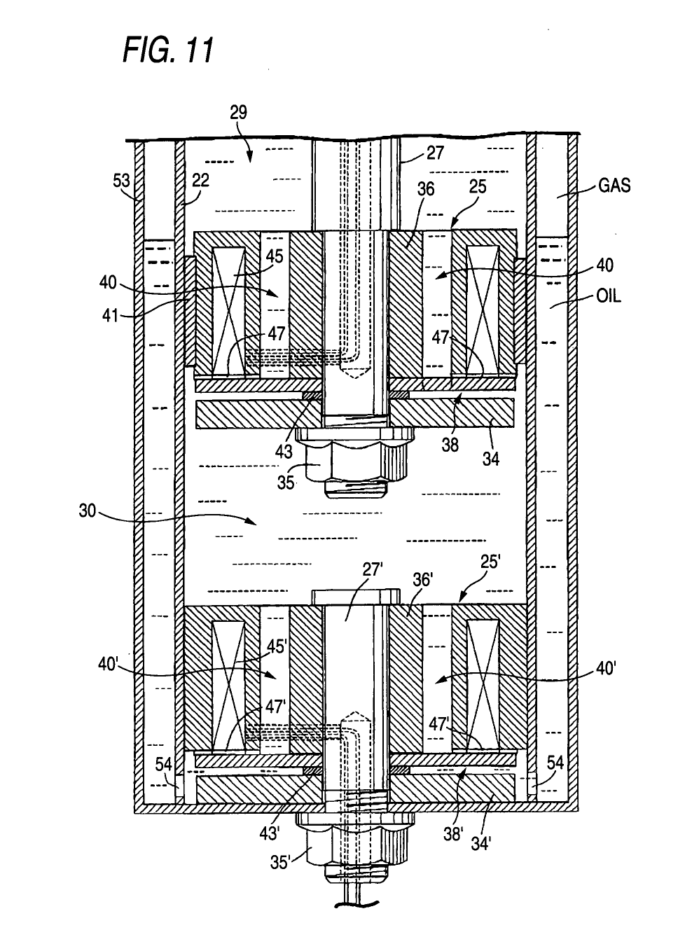

Next, a third embodiment of the invention will be described with reference to FIG. 11.

In the third embodiment, a cylindrical reservoir room 53 is formed so as to surround the periphery of a cylinder 22, and the lower end of the cylinder 22 and the lower end of the reservoir room 53 communicate with each other through plural communication holes 54. The inside of the cylinder 22 and the lower half portion of the reservoir room 53 are filled with oil, and the upper half portion of the reservoir room 53 is filled with gas.

A movable piston 25 which fits slidably into the cylinder 22 has substantially only the constitution of the lower half portion of the piston 25 (refer to FIG. 5) in the first embodiment. Namely, the movable piston 25 includes a piston body 36, a first coil 45, fluid passages 39, fluid passages 40, first orifices 47, a first valve plate 38, a shim 43, a stopper plate 34 and a piston ring 41. In the fluid passages 39, first check valves 55 which permit passage of the fluid from the downside to the upside and checks passage of the fluid in the reverse direction are provided, and in the first valve plate 38 opposing to the lower ends of the fluid passages 39, permeable pores 38a are formed.

Further, a fixed piston 25′ which is fixed at the bottom of the cylinder 22 by a piston rod 27′ and a nut 35′ has the substantially same constitution as that of the movable piston 25. The fixed piston 25′ includes a piston body 36′, a second coil 45′, fluid passages 39′, fluid passages 40′, second orifices 47′, a second valve plate 38′, a shim 43′, and a stopper plate 34′. In the fluid passages 39′, second check valves 55′ which permit passage of the fluid from the downside to the upside and checks passage of the fluid in the reverse direction are provided, and in the second valve plate 38′ opposing to the lower ends of the fluid passages 39′, permeable pores 38a′ are formed. Since the fixed piston 25′ does not move in relation to the cylinder 22, it does not include a piston ring 41.

When the first coil and second coil 45, 45′ are not excited, a damper 14 contracts and the movable piston 25 moves down in relation to the cylinder 22. Then, the magnetic viscous fluid corresponding to the volume of the piston rod 27 which has entered the cylinder 22 is checked by the closed check valve 55′ of the fixed piston 25′, and moves from the second fluid chamber 30 through the second orifices 47′ of the fixed piston 25′ to the reservoir room 53. At this time, since the opening of the second orifices 47′ does not increase due to elasticity of the second valve plate 38′, the attenuation power of the damper 14 increases quickly. Though the volume of the second fluid chamber 30 decreases by the down-movement of the movable piston 25 and the volume of the first fluid chamber 29 increases, since the fluid moves from the second fluid chamber 30 through the opened check valves 55 of the movable piston 25 to the first fluid chamber 29, the pressure in the first fluid chamber 29 becomes equal to that in the second fluid chamber 30.

When the down-moving speed of the movable piston 25 comes to V1 in FIG. 8, the second valve plate 38′ of the fixed piston 25′ yields under fluid pressure and curves downward, and the second orifices 47′ come not to work. Therefore, accordingly to the increase in the down-moving speed of the movable piston 25, the attenuation power of the damper 14 increases linearly (refer to an a-line).

At this time, when the second coil 45′ is energized by an instruction from the electronic control unit U, the second valve plate 38′ is about to deform upward due to the magnetic field generated by the second coil 45′ and the set load in the valve closing direction is produced. Therefore, till the down-moving speed of the movable piston 25 increases more and comes to V2 in FIG. 8, the second valve plate 38′ does not open, and rising of the attenuation power of the damper 14 becomes strong due to the function of the second orifices 47′ (refer to a b-line). Accordingly, by changing the electric current to be supplied to the second coil 45′, the attenuation power of the damper 14 can be controlled arbitrarily.

To the contrary, when the first and second coils 45 and 45′ are not excited, in case that the damper 14 expands and the movable piston 25 moves up in relation to the cylinder 22, the magnetic viscous fluid corresponding to the volume of the piston rod 27 which has come out of the cylinder 22 moves from the reservoir room 53 through the opened check valves 55′ of the fixed piston 25′ to the second fluid chamber 30. However, since the decrease in volume of the second fluid chamber 30 due to the up-movement of the movable piston 25 is larger than the inflow amount of the magnetic viscous fluid from the reservoir room 53 to the second fluid chamber 30, the fluid in the first fluid chamber 29 is checked by the closed check valves 55 of the movable piston 25, and moves through the first orifices 47 of the movable piston 25 to the second fluid chamber 30. At this time, since the opening of the first orifices 47 does not increase due to elasticity of the first valve plate 38, the attenuation power of the damper 14 increases quickly.

When the up-moving speed of the movable piston 25 comes to V1 in FIG. 8, the first valve plate 38 of the movable piston 25 yields under fluid pressure and curves downward, and the first orifices 47 come not to work. Therefore, accordingly to the increase in the up-moving speed of the movable piston 25, the attenuation power of the damper 14 increases linearly (refer to the a-line).

At this time, when the first coil 45 is energized by an instruction from the electronic control unit U, the first valve plate 38 is about to deform upward due to the magnetic field generated by the first coil 45 and the set load in the valve closing direction is produced. Therefore, till the up-moving speed of the movable piston 25 increases more and comes to V2 in FIG. 8, the first valve plate 38 does not open, and rising of the attenuation power of the damper 14 becomes strong due to the function of the first orifices 47 (refer to the b-line) Accordingly, by changing the electric current to be supplied to the first coil 45, the attenuation power of the damper 14 can be controlled arbitrarily.

Thus, also in this third embodiment, the first coil 45 is exited only in the up-moving time of the movable piston 25, and the second coil 45′ is exited only in the down-moving time of the movable piston 25. In result, the first and second coils 45, 45′ only perform a cycle of excitation and demagnetization only once per cycle of expansion and contraction of the damper 14. Therefore, the cycle of the electric current to be supplied to the first and second coils 45, 45′ is prolonged twice to make it difficult to receive the influence of inductance, whereby the delay of rising of the electric current can be suppressed to a minimum and the response can be heightened.

Further, according to the third embodiment, the free piston 28 and the gas chamber 32 (refer to FIG. 2) which are necessary in the first embodiment become unnecessary. Therefore, it is eliminated that the gas chamber 32 is put in a high-pressure state when the movable piston 25 moves down quickly, so that the countermeasure such as seal is facilitated and the structure can be simplified.

What is claimed is:

1. A variable attenuation power damper comprising:
a cylinder filled with viscous fluid;
a piston which is fitted slidably into the cylinder and separates the cylinder into first and second fluid chambers;
a piston rod which is coupled to the piston and penetrates an end wall of the cylinder;
orifices which are provided in the piston and through which the first and second fluid chambers are communicated with each other; and
an attenuation power control mechanism which controls attenuation power by changing the opening of the orifices of the piston, wherein
the attenuation power control mechanism includes:
first and second valve plates which are made of magnetic alloy and arranged at both ends in the axial direction of the piston; and
first and second coils which are arranged in the piston to correspond to the first and second valve plates respectively, and
the first and second valve plates are respectively deformed by magnetic fields generated by the first and second coils to change the opening of the orifices.

2. The variable attenuation power damper according to claim 1, wherein
the piston includes fluid passages which communicate the first and second fluid chambers with each other in cooperation with the orifices, and
the fluid passages are arranged on the inside in the diametrical direction of the first and second coils provided in the piston.

3. A variable attenuation power damper comprising:
a cylinder filled with viscous fluid;
a piston which is fitted slidably into the cylinder and separates the cylinder into first and second fluid chambers;
a piston rod which is coupled to the piston and penetrates an end wall of the cylinder;
orifices which are provided in the piston and through which the first and second fluid chambers are communicated with each other; and
an attenuation power control mechanism which controls attenuation power by changing the opening of the orifices of the piston, wherein
the viscous fluid is composed of magnetic viscous fluid or magnetic fluid; and
the attenuation power control mechanism includes valve plates which are made of magnetic alloy and arranged in the piston and coils, and
the valve plates are deformed by magnetic fields generated by the coils to change the opening of the orifices.

4. The variable attenuation power damper according to claim 3, wherein
the valve plate includes first and second valve plates arranged at both ends in the axial direction of the piston, and
the coil includes first and second coils respectively corresponding to the first and second valve plates.

5. The variable attenuation power damper according to claim 2, wherein
a piston body of the piston is formed of one member from one end in its axial direction to the other end.

6. The variable attenuation power damper according to claim 1, wherein
the piston rod is inserted from one end in the axial direction of the piston and located on this side of the other end in the axial direction thereof.

7. A variable attenuation power damper comprising:
a cylinder filled with viscous fluid;
a reservoir room which is arranged so as to surround the periphery of the cylinder, communicates at its lower portion with the cylinder to be filled with the viscous fluid, and is filled at its upper portion with gas;
a movable piston which is fitted into the cylinder slidably and divides the cylinder into first and second fluid chambers;
a piston rod which is coupled to the movable piston and penetrates an end wall of the cylinder;
a first orifice which is provided in the movable piston and through which the first and second fluid chambers are communicated with each other;
a first attenuation power control mechanism which changes the opening of the first orifice of the movable piston to control the attenuation power;
a fixed piston which is fixed at the bottom of the cylinder so as to define the second fluid chamber and the reservoir room;
a second orifice which is provided in the fixed piston and through which the second fluid chamber and the reservoir room are communicated with each other; and
a second attenuation power control mechanism which changes the opening of the second orifice of the fixed piston to control the attenuation power, wherein
the first attenuation power control mechanism includes a first valve plate made of magnetic alloy which is arranged at the lower end in the axial direction of the movable piston, and a first coil arranged in the movable piston so as to correspond to the first valve plate, and deforms the first valve plate by the magnetic field generated by the first coil to change the opening of the first orifice; and
the second attenuation power control mechanism includes a second valve plate made of magnetic alloy which is arranged at the lower end in the axial direction of the fixed piston, and a second coil arranged in the fixed piston so as to correspond to the second valve plate, and deforms the second valve plate by the magnetic field generated by the second coil to change the opening of the second orifice.
